(19) United States
(12) Patent Application Publication
(10) Pub. No.: US 2020/0324681 A1
(43) Pub. Date: Oct. 15, 2020

(54) ADJUSTABLE CUP HOLDER FOR A VEHICLE

(71) Applicant: Kuryakyn Holdings, LLC, Somerset, WI (US)

(72) Inventor: Jay N. Rogers, Hudson, WI (US)

(21) Appl. No.: 16/383,757

(22) Filed: Apr. 15, 2019

(51) Int. Cl. B60N 3/10; B62J 11/00

(52) U.S. Cl. CPC B60N 3/108; B60Y 2200/12; B62J 11/00

(57) ABSTRACT

A cup holder may include a base having a threaded flange configured to mount the cup holder. A pair of arms may be hingedly coupled to the base and may extend from the base to define an opening. Each of the pair of arms may be moveable to vary a size of the opening. A basket may be formed from a flexible material and coupled to the pair of arms. A cavity may extend from a bottom of the basket to the opening formed between the pair of arms.

### BACKGROUND

The present disclosure relates to cup holders, and more particularly, to an adjustable cup holder for a motorcycle.

Some motorcycles may be adapted to mount a cup holder for the rider or passenger. Unfortunately, many cup holders are limited in size. Particularly, a cup holder may be too wide for the rider's beverage or the cup holder may be too small for the rider's beverage. Some cup holders provide limited adjustability, but typically only a top portion of the cup holder adjusts. Accordingly, larger beverages may still not fit in the lower portion of the cup holder.

### SUMMARY

The present disclosure includes one or more of the features recited in the appended claims and/or the following features which, alone or in any combination, may comprise patentable subject matter.

According to an aspect of the disclosed embodiments, a cup holder may include a base having a threaded flange configured to mount the cup holder. A pair of arms may be hingedly coupled to the base and may extend from the base to define an opening. Each of the pair of arms may be moveable to vary a size of the opening. A basket may be formed from a flexible material and coupled to the pair of arms. A cavity may extend from a bottom of the basket to the opening formed between the pair of arms. The basket may be deformable by moving the pair of arms to vary a size of the cavity.

In some embodiments, each of the pair of arms may include an arm slot. A top of the basket may be retained in the arm slot. The base may include a base slot. A top of the basket may be retained in the base slot.

Optionally, a plurality of apertures may be formed through the basket. The basket may include a plurality of webs connected together. The apertures may be defined between adjacent webs.

In some embodiments, each of the pair of arms may be moveable between a retracted position and an expanded position. When the pair of arms is in the retracted position, the basket may be contracted. When the pair of arms is in the expanded position, the basket may be expanded. When the basket is contracted, the cavity may have a first capacity. When the basket is expended, the cavity may have a second capacity that may be greater than the first capacity.

It may be desired that a mount pivotally couples to the threaded flange. The mount may be configured to couple to a handlebar of a motorcycle.

According to another aspect of the disclosed embodiments, a cup holder may include an upper assembly having a base and a pair of arms hingedly coupled to the base. An opening may be defined between the pair of arms. A lower assembly may have a closed bottom and a webbed side wall extending upward from the closed bottom. The webbed side wall may define a cavity. A top of the webbed side wall may be coupled to the pair of arms. Each of the pair of arms may be movable to vary the wedded side wall and vary a size of the cavity.

In some embodiments, each of the pair of arms may include an arm slot. The top of the webbed side wall may be retained in the arm slot. The base may include a base slot. The top of the webbed side wall may be retained in the base slot.

Optionally, the webbed side wall may include a plurality of apertures. The webbed side wall may include a plurality of webs connected together. The apertures may be defined between adjacent webs.

In some embodiments, each of the pair of arm may be moveable between a retracted position and an expanded position. When the pair of arms is in the retracted position, the webbed side wall may be contracted. When the pair of arms is in the expanded position, the webbed side wall may be expanded. When the webbed side wall is contracted, the cavity may have a first capacity. When the webbed side wall is expended, the cavity may have a second capacity that may be greater than the first capacity.

It may be contemplated that a mount pivotally couples to the base. The mount may be configured to couple to a handlebar of a motorcycle.

According to yet another aspect of the disclosed embodiments, a method of assembling an expandable cup holder may include hingedly coupling a pair of arms to a base so that the each of the pair of arms extends from the base to define an opening. Each of the pair of arms may be moveable to vary a size of the opening. The method may also include coupling a basket formed from a flexible material to the pair of arms. A cavity may extend from a bottom of the basket to the opening formed between the pair of arms. The basket may be deformable by moving the pair of arms to vary a size of the cavity.

In some embodiments, the method may also include retaining a top of the basket in an arm slot formed in each of the pair of arms. The method may also include retaining a top of the basket in a base slot formed in the base.

### BRIEF DESCRIPTION OF THE DRAWINGS

The detailed description particularly refers to the accompanying figures in which:

FIG. 1 is a top perspective view of a cup holder in accordance with an embodiment and in a contracted position;

FIG. 2 is an exploded view of the cup holder shown in FIG. 1;

FIG. 3 is a bottom perspective view of an upper assembly of the cup holder including a base and a pair of arms extending from the base;

FIG. 4 is a rear elevation view of the upper assembly having a threaded flange extending from the base;

FIG. 5 is a top perspective view of the cup holder shown in FIG. 1 in an expanded position;

FIG. 6 is an exploded view of a cup holder assembly having the cup holder shown in FIG. 1 and a motorcycle mount,

FIG. 7 is an exploded view of a handlebar mount; and

FIG. 8 is a perspective view of a passenger mount.

### DETAILED DESCRIPTION

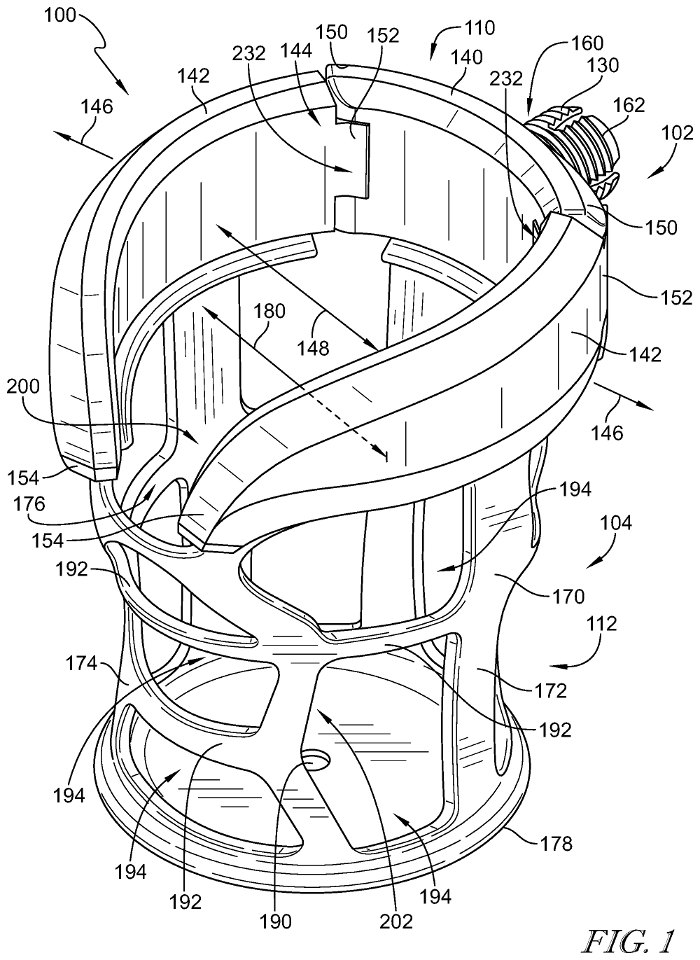

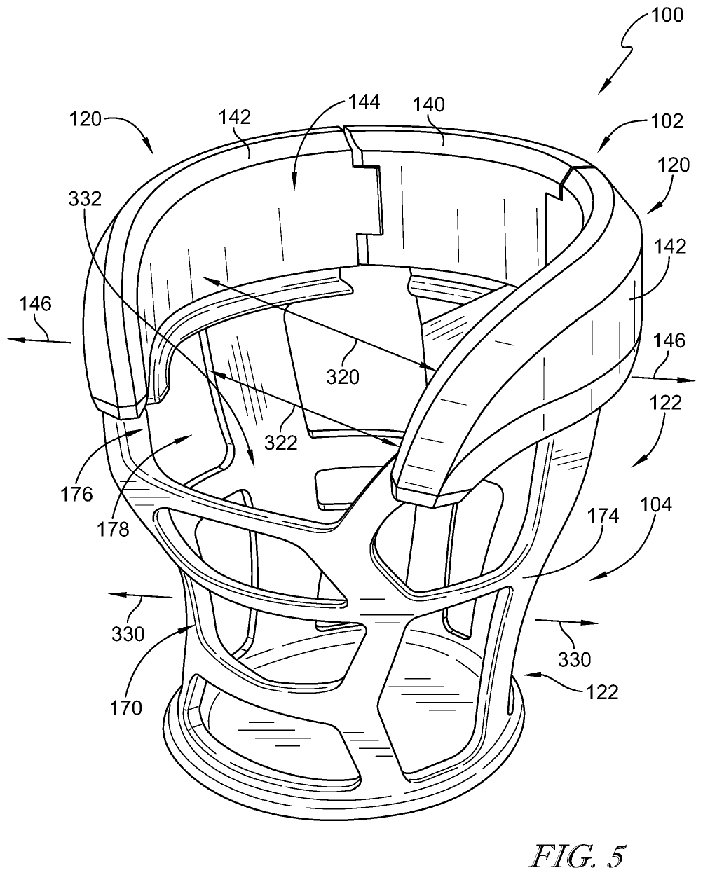

Referring to FIG. 1, a holder 100 includes an upper assembly 102 and a lower assembly 104. The upper assembly 102 is illustrated in contracted position 110. Likewise, the lower assembly 104, is illustrated in a contracted position 112. The upper assembly 102 is configured to expand to an expanded position 120 (shown in FIG. 5) to expand the lower assembly 104 to an expanded position 122 (shown in FIG. 5). By expanding both the upper assembly 102 and the lower assembly 104, the holder 100 is configured to retain containers, such as cups, for example, of varying sizes. The holder 100 is described herein as being used with a motorcycle (not shown). However, it should be appreciated that the holder 100 may be utilized with any vehicle, for example, an automobile, truck, plane, train, etc. The holder 100 may also be utilized with apparatuses other than motorized vehicles, for example, wagons, water vehicles, such as rafts, lawn chairs, etc. The holder 100 is described as having a mounting flange 130 (described in more detail below); however, the mounting flange 130 may be adapted for utilizing the holder 100 with apparatuses other than a motorcycle.

The upper assembly 102 includes a base 140 and a pair of arms 142 hingedly coupled to the base 140. An opening 144 is defined between the arms 142 and the base 140. In the fully contracted position 112, the opening 144 has a width 148. Each of the arms 142 is configured to rotate outward relative to the base 140 in the direction of arrows 146 to expand a size of the opening 144. The base 140 includes a pair of opposite ends 150. A fixed end 152 of each arm 142 is coupled to a respective end 150 of the base 140. The arm 142 is configured to rotate relative to the respective end 150 to move a free end 154 of the arm 142.

The mounting flange 130 extends from a back end 160 of the base 140. In the illustrative embodiment, the mounting flange 130 is centered between the ends 150 of the base 140. The mounting flange 130 includes a threaded post 162 that is configured to receive a threaded nut 164 (described in more detail below). It should be appreciated that the mounting flange 130 may be configured with other coupling mechanisms other than a threaded post 162. Additionally, the mounting flange 130 may be altered to accommodate coupling the holder 100 to different vehicles, etc.

The lower assembly 104 includes a deformable basket 170 that is formed from a resiliently deformable material 172, such as rubber. The flexible material 172 enables the basket 170 to deform and expand in size. The basket 170 includes a sidewall 174 that extends from an open end 176 to a closed bottom 178. The open end 176 is aligned with the opening 144 of the upper assembly 102. The open end 176 defines an opening 178 that has a width 180 that corresponds to the width 148 of the opening 144. In the illustrative embodiment, the closed bottom 178 includes a drain hole 190 that is configured to enable fluids to drain from the holder 100.

The sidewall 174 includes a plurality of webs 192 that interconnect between the open end 176 and the closed bottom 178. Apertures 194 are defined between the webs 192. The configuration of the webs 192 and apertures 194 permit the sidewall to expand between the contracted position 112 and the expanded position 122. It will be appreciated that the configuration of the webs 192 and apertures 194 may be altered to alter a deformation characteristic of the basket 170.

A cavity 200 is defined by the sidewall 174. The cavity 200 extends from the open end 176 to the closed bottom 178. In the contracted position 112, the cavity 200 has a capacity 202. The basket 170 is deformable to alter the capacity of the cavity 200. That is, as the arms 142 are expanded from the contracted position 110 to the expanded position 120, the basket 170 likewise expands from the contracted position 112 to the expanded position 122 to vary the capacity of the cavity 200.

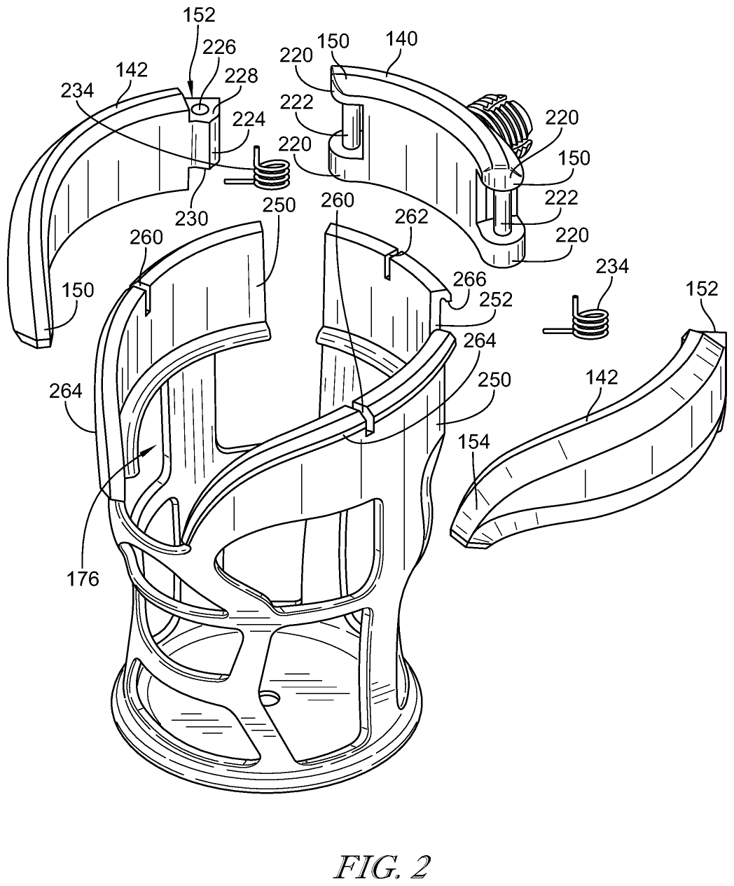

Referring now to FIG. 2, each end 150 of the base 140 includes a pair of flanges 220 and a hinge pin 222 extending between the flanges 220. The fixed end 152 of each arm 142 includes a tab 224 having a bore 226 extending from a top 228 of the tab 224 to a bottom 230 of the tab 224. The tab 224 is sized to position between the flanges 220 so that the hinge pin 222 extends through the bore 226 and a spring 324 to create a hinge 232 (shown in FIG. 1). The arms 142 are configured to rotate relative to the hinge pin 222. In should be noted that other hinge configurations are contemplated, for example, the base 140 and the arms 142 may be coupled by a living hinge, in some embodiments.

The open end 176 of the basket 170 includes a pair of arm flanges 250 and a base flange 252. Each arm flange 250 is configured to couple to a respective arm 142. The base flange 252 is configured to couple to the base 140. Each arm flange 250 includes a slot 260 configured to align the arm flange 250 with the respective arm 142. The base flange 252 likewise includes a slot 262 to align the base flange 252 with the base 140. Each arm flange 250 includes a tab 264 that is configured to secure the arm flange 250 to the respective arm 142. The base flange 252 includes a tab 266 that is configured to secure the base flange 252 to the base 140.

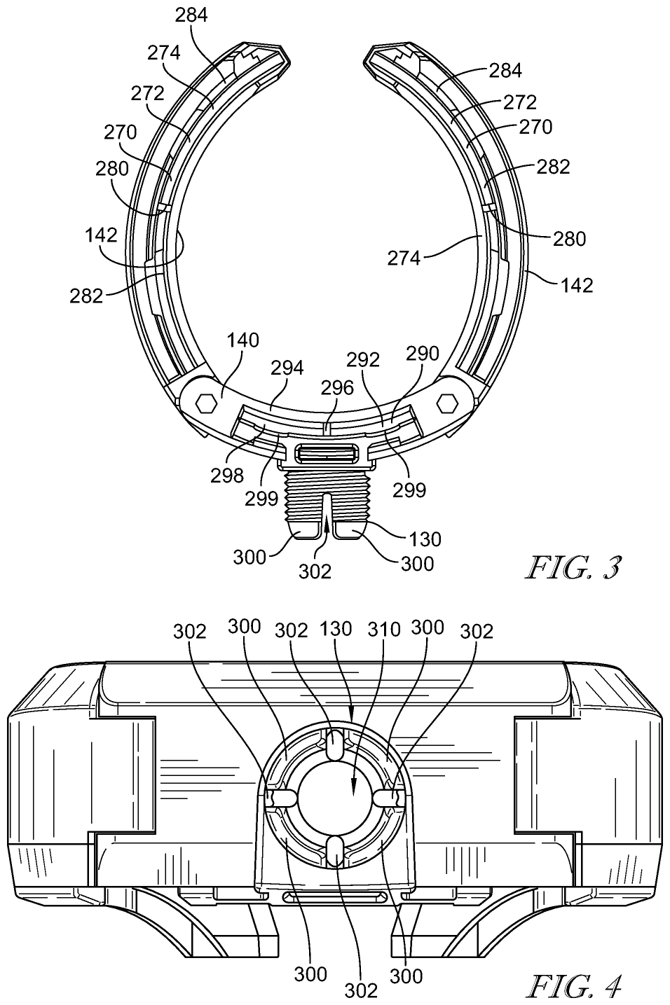

As illustrated in FIG. 3, each arm 142 includes an arm slot 270 that is sized to receive the arm flange 250 of the basket 170. The slot 270 extends from an opening 272 in a bottom 274 of the arm 142 and into the arm 142. A tab 280 is positioned at an end 282 of the slot 270. The tab 280 aligns with and is received in the slot 260 of the arm flange 250 to align the arm flange 250 within the slot 270. A lip 284 is formed along the opening 272 of the slot 270. The tab 264 of the arm flange 250 is configured to secure to the lip 284 to retain the arm flange 250 within the slot 270.

The base 140 includes a base slot 290 that is sized to receive the base flange 252 of the basket 170. The slot 290 extends from an opening 292 in a bottom 294 of the base 140 and into the base 140. A tab 296 is positioned at an end 298 of the slot 290. The tab 294 aligns with and is received in the slot 262 of the base flange 252 to align the base flange 252 within the slot 290. A lip 299 is formed along the opening 292 of the slot 290. The tab 266 of the base flange 252 is configured to secure to the lip 299 to retain the base flange 252 within the slot 290.

The mounting flange 130 includes a plurality of threaded posts 300 are separated by gaps 302. The gaps 302 enable the posts 300 to contract inward when the nut 164 is secured to the mounting flange 130. As illustrated in FIG. 4, an opening 310 is formed between the posts 300. As the nut 164 is secured to the posts 300, the posts 300 move inward to decrease a size of the opening 310, as described in more detail below.

FIG. 5 illustrates the holder 100 in the expanded positions 120, 122. In the expanded positions 120, 122 the arms 142 are rotated outward in the direction of arrows 146 so that the opening 144 has a width 320 that is greater than the width 148. As the arms 142 expand outward, the basket 170 deforms so that the opening 178 of the open end 176 has a width 322 that is greater than the width 180. The width 322 corresponds to the width 320. As the opening 178 expands the sidewall 174 of the basket 170 also expands outward in the direction of arrows 330 causing the capacity of the basket 170 to increase to capacity 332 that is greater than the capacity 202.

It should be noted that the holder 100 may expand to intermediate positions between the contracted positions 110, 112 and the expanded positions 120, 122. The holder 100 is configured to expand between the contracted positions 110, 112 and the expanded positions 120, 122 to conform to a diameter of a container being placed in the holder 100. Accordingly, the opening 144 may be expanded to an intermediate width between width 148 and width 320. The opening 178 may be expanded to an intermediate width between width 180 and width 322. Also, the capacity of the basket 170 may be expanded to an intermediate capacity between capacity 202 and capacity 332.

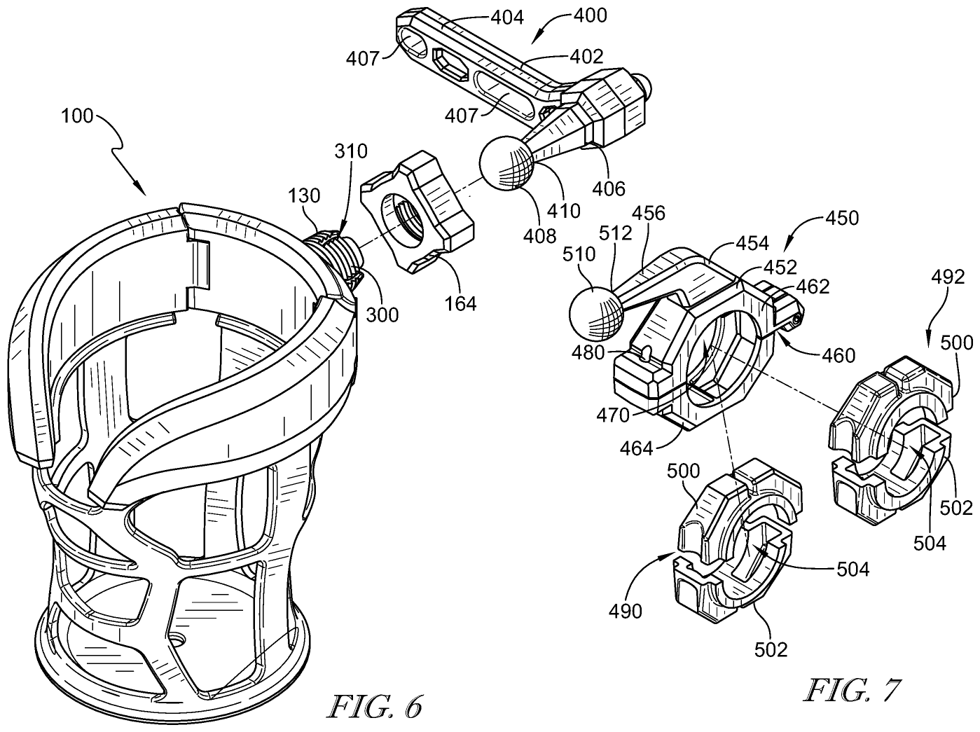

Referring to FIGS. 6 and 7, the holder 100 may be mounted to a motorcycle with different mounting assemblies. A mounting assembly 400 is configured to couple the holder 100 to a body of the motorcycle. The mounting assembly 400 includes a mount 402 having an arm 404 and a mating post 406 extending from the arm 404. The arm 404 includes apertures 407 to receive bolts, or the like, to secure the arm 404 to the motorcycle. A ball 408 is positioned at an end 410 of the mating post 406. The ball 408 is configured to be received within the opening 310 of the mounting flange 130. As the nut 164 is secured to the posts 300 of the mounting flange 130, the posts 300 contract inward to secure the ball 408 within the opening 310. Once secured, the ball 408 is movable within the opening 310 to rotate an orientation of the holder 100.

Referring to FIG. 7, a mounting assembly 450 is configured to mount the holder 100 to a handlebar of a motorcycle. The mounting assembly 450 includes a mount 452 having an arm 454 and a mounting post 456 extending from the arm 454. A bracket 460 extends from the arm 454. The bracket 460 includes an upper bracket 462 and a lower bracket 464 hingedly secured to the upper bracket 462. A handlebar opening 470 extends between the upper bracket 462 and the lower bracket 464. The upper bracket 462 and the lower bracket 464 are configured to be secured around the handlebar so that the handle bar extends through the handlebar opening 470. The upper bracket 462 is secured to the lower bracket 464 by inserting a fastener (not shown) through a bore 480 extending through the upper bracket 462 and the lower bracket 464 to clamp the upper bracket 462 and the lower bracket 464 onto a handle bar (not shown).

Handlebar inserts 490, 492 may be positioned within the handlebar opening 470 to accommodate different diameter handle bars. Each insert 490, 492 includes an upper insert 500 and a lower insert 502. In some embodiments, the upper insert 500 and the lower insert 502 may be formed from a resiliently deformable material, such as rubber. The upper inserts 500 and lower inserts 502 are inserted into the handlebar opening 470 to form an insert opening 504. The size of the insert opening 504 of the insert 490 is smaller than the size of the handlebar opening 470 to accommodate smaller handlebars. The size of the insert opening 504 of the insert 492 is smaller than the size of the insert opening 504 of the insert 490 to accommodate even smaller handlebars.

A ball 510 is positioned at an end 512 of the mating post 456. The ball 510 is configured to be received within the opening 310 of the mounting flange 130. As the nut 164 is secured to the posts 300 of the mounting flange 130, the posts 300 move inward to secure the ball 510 within the opening 310. Once secured, the ball 510 is movable within the opening 310 to rotate an orientation of the holder 100.

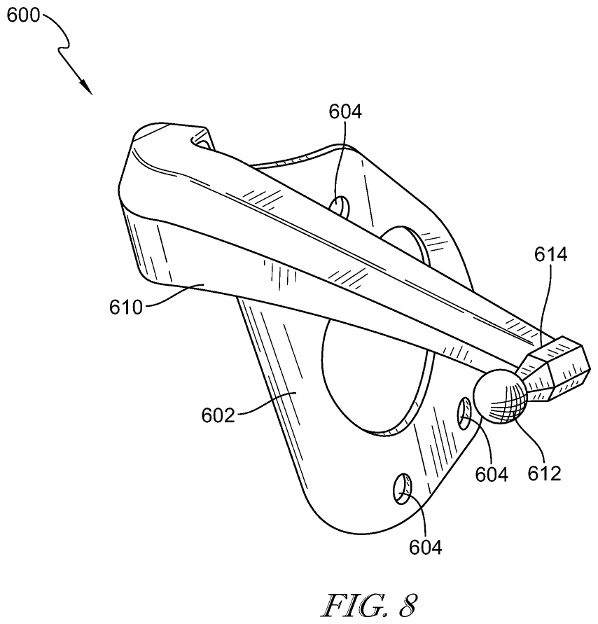

FIG. 8 illustrates a passenger mount 600 that mounts to a vehicle, for example, the passenger mount 600 may be configured to mount behind a speaker of a motorcycle. The passenger mount 600 includes a base plate 602 that is configured to mount to the vehicle. The base plate 602 includes openings 604 that are configured to receive fasteners to secure the base plate to the vehicle. An arm 610 extends from the base plate 602. A ball 612 extends outward from an end 614 of the arm 610.

The ball 612 is configured to be received within the opening 310 of the mounting flange 130. As the nut 164 is secured to the posts 300 of the mounting flange 130, the posts 300 move inward to secure the ball 612 within the opening 310. Once secured, the ball 612 is movable within the opening 310 to rotate an orientation of the holder 100.

Although this disclosure refers to specific embodiments, it will be understood by those skilled in the art that various changes in form and detail may be made without departing from the subject matter set forth in the accompanying claims.

1. A cup holder, comprising:
a base having a threaded flange configured to mount the cup holder,
a pair of arms hingedly coupled to the base and extending from the base to define an opening, each of the pair of arms being moveable to vary a size of the opening, and
a basket formed from a flexible material and coupled to the pair of arms, wherein a cavity extends from a bottom of the basket to the opening formed between the pair of arms, wherein the basket is deformable by moving the pair of arms to vary a size of the cavity.

2. The cup holder of claim 1, wherein each of the pair of arms includes an arm slot, and a top of the basket is retained in the arm slot.

3. The cup holder of claim 2, wherein the base includes a base slot, and a top of the basket is retained in the base slot.

4. The cup holder of claim 1, further comprising a plurality of apertures formed through the basket.

5. The cup holder of claim 4, wherein the basket includes a plurality of webs connected together, wherein the apertures are defined between adjacent webs.

6. The cup holder of claim 1, wherein each of the pair of arms is moveable between a retracted position and an expanded position, wherein, when the pair of arms is in the retracted position, the basket is contracted, and, when the pair of arms is in the expanded position, the basket is expanded.

7. The cup holder of claim 6, wherein, when the basket is contracted, the cavity has a first capacity, and, when the basket is expended, the cavity has a second capacity that is greater than the first capacity.

8. The cup holder of claim 1, further comprising a mount that pivotally couples to the threaded flange.

9. The cup holder of claim 8, wherein the mount is configured to couple to a handlebar of a motorcycle.

10. A cup holder, comprising:
an upper assembly having a base and a pair of arms hingedly coupled to the base, wherein an opening is defined between the pair of arms, and
a lower assembly having a closed bottom and a webbed side wall extending upward from the closed bottom, the webbed side wall defining a cavity, wherein a top of the webbed side wall is coupled to the pair of arms,
wherein each of the pair of arms is movable to vary the webbed side wall and vary a size of the cavity.

11. The cup holder of claim 10, wherein each of the pair of arms includes an arm slot, and the top of the webbed side wall is retained in the arm slot.

12. The cup holder of claim 11, wherein the base includes a base slot, and the top of the webbed side wall is retained in the base slot.

13. The cup holder of claim 10, wherein the webbed side wall includes a plurality of apertures.

14. The cup holder of claim 13, wherein the webbed side wall includes a plurality of webs connected together, wherein the apertures are defined between adjacent webs.

15. The cup holder of claim 10, wherein each of the pair of arm is moveable between a retracted position and an expanded position, wherein, when the pair of arms is in the retracted position, the webbed side wall is contracted, and, when the pair of arms is in the expanded position, the webbed side wall is expanded.

16. The cup holder of claim 15, wherein, when the webbed side wall is contracted, the cavity has a first capacity, and, when the webbed side wall is expended, the cavity has a second capacity that is greater than the first capacity.

17. The cup holder of claim 10, further comprising a mount that pivotally couples to the base.

18. The cup holder of claim 17, wherein the mount is configured to couple to a handlebar of a motorcycle.

19. A method of assembling an expandable cup holder, comprising:
hingedly coupling a pair of arms to a base so that the each of the pair of arms extends from the base to define an opening, wherein each of the pair of arms is moveable to vary a size of the opening, and
coupling a basket formed from a flexible material to the pair of arms, wherein a cavity extends from a bottom of the basket to the opening formed between the pair of arms, wherein the basket is deformable by moving the pair of arms to vary a size of the cavity.

20. The method of claim 19 further comprising:
retaining a top of the basket in an arm slot formed in each of the pair of arms, and
retaining a top of the basket in a base slot formed in the base.
